(19) United States
(12) Patent Application Publication
(10) Pub. No.: US 2008/0275750 A1
(43) Pub. Date: Nov. 6, 2008

(54) Method and system for processing and communicating corporate action events

(75) Inventors: Terry Robinson, Haywards Heath (GB); Iain Craig, London (GB)

Correspondence Address: KING & SPALDING;CREDIT SUISSE SECURITIES (USA) LLC, 1180 PEACHTREE STREET, NE, 34TH FLOOR, ATLANTA, GA, 30309-3521, US

(73) Assignee: Credit Suisse Securities (USA) LLC

(21) Appl. No.: 11/800,418

(22) Filed: May 4, 2007

(51) Int. Cl. G06F 9/46

(52) U.S. Cl. 705/8

(57) ABSTRACT

Providing for processing and communicating corporate action events and any associated elections. These systems and methods enable straight through processing of corporate action events, including events requiring the election of optional events by a security holder. These systems and methods would receive and process data regarding corporate action events. These data would be processed and notifications sent to affected security holders. For events that require the security holder to make an election, the systems and methods may receive and process those elections. The elections would then be used to implement the resulting outcome. An exemplary embodiment of the present invention would employ XML messaging in the automation process. The systems and methods may also include a process that can identify and, if possible, fix an exception to a message or data stream. Also, an asset servicing portal may be used for communicating notifications and elections.

### FIELD OF THE INVENTION

This invention relates to systems and methods for processing and communicating corporate action events. More specifically, this invention relates to systems and methods for receiving data associated with corporate action events and processing the data to create notification messages and further processing any resulting election for corporate action events.

### BACKGROUND OF THE INVENTION

Corporate action events occur every day and are a key component of capital markets. A corporate action event occurs when a company's capital structure or financial position changes, effecting a security, such as stock, issued by that company. Company stock buy-backs, elective dividends, tender offers, corporate mergers, stock splits, redemptions, spin-offs, rights issues, and periodic income payments are a few examples of the almost 1 billion corporate action events that occur in a single year worldwide.

Information clearinghouses provide information services regarding corporate action events to asset servicing organizations. Examples of such clearinghouses include the Depository Trust & Clearing Corporation (DTCC) and the International Income Corporate Action Processing System (IICAPS). These clearinghouses process information from companies and securities exchanges, such as a stock exchange, and deliver the information to asset servicing organizations. Possibly, third party data processors may serve as data processing intermediaries between the data clearinghouses and the asset servicing organizations. No single standard exists for corporate action event data and each data clearinghouses and third-party processor may provide data to the asset servicing organizations in different formats and structures.

Corporate action events can be simple or complex. These events can require holders of securities for the company to take actions. These actions can be mandatory or optional. In the case of optional actions, the security holder must elect an option, often by an expiration date. Today, election processing is a labor-intensive, manual process. Communication between a financial organization that services assets and their customers, the securities holders, often takes place using facsimile transmissions and telephone calls. Data associated with an election are often re-keyed by the asset servicing organization. This manual process can result in errors and often requires significant customer service support.

What is needed are systems and methods for automating the notification and election process resulting from these corporate action events, allowing for straight through processing (STP) of corporate action events. These systems and methods should minimize human involvement in the process to increase reliability and decrease costs.

### SUMMARY OF THE INVENTION

The present invention provides systems and methods for automating the notification and election process resulting from corporate action events. In one aspect of the present invention, a system for processing corporate action events is provided. The system includes an event, holdings, entitlement, and election (EHEE) message processor module operable to receive data associated with a corporate action event; and a notification processor module, logically connected to the EHEE message processor module and operable to process the received data associated with a corporate action event and automatically create a notification message, where the notification message comprises an option that must be taken by a holder of a security affected by the corporate action event.

In another aspect of the present invention, a method for processing corporate action events is provided. The method includes the steps of (1) receiving EHEE data associated with a corporate action event from an EHEE data clearinghouse; (2) automatically generating a notification message to notify a holder of a security affected by the corporate action event, where the notification message comprises an option that must be taken by the security holder; and (3) sending the notification message to the holder of a security affected by the corporate action event.

In yet another aspect of the present invention, a system for processing corporate action events is provided. The system includes an EHEE message processor module operable to receive data associated with a corporate action event; a notification processor module, logically connected to the EHEE message processor module and operable to process the received data associated with a corporate action event and automatically create a notification message, where the notification message comprises an option that must be taken by a holder of a security affected by the corporate action event; an asset servicing portal, operable to communicate the notification message to the holder of a security affected by the corporate action event; and an election processor module operable to receive an election from the holder of a security affected by the corporate action event in response to the notification message.

In yet another aspect of the present invention, a system for processing corporate action events is provided. The system includes an EHEE message processor module operable to receive data associated with a corporate action event from a plurality of EHEE data providers and normalize the received data; and a notification processor module, logically connected to the EHEE message processor module and operable to process the received data associated with a corporate action event and automatically create a notification message, where the notification message comprises an option that must be taken by a holder of a security affected by the corporate action event.

### BRIEF DESCRIPTION OF THE DRAWINGS

FIG. 1 depicts an operating environment in accordance with an exemplary embodiment of the present invention.

FIG. 2 depicts a software architecture in accordance with an exemplary embodiment of the present invention.

FIG. 3 depicts an overall process flow diagram in accordance with an exemplary embodiment of the present invention.

FIG. 4 depicts a process flow diagram for creating an event message in accordance with an exemplary embodiment of the present invention.

FIG. 5 depicts a process flow diagram for harmonizing event data in accordance with an exemplary embodiment of the present invention.

FIG. 6 depicts a process flow diagram for processing event notification in accordance with an exemplary embodiment of the present invention.

FIG. 7 depicts a process flow diagram for an asset services portal processing an event notification in accordance with an exemplary embodiment of the present invention.

FIG. 8 depicts a process flow diagram for processing an exception in accordance with an exemplary embodiment of the present invention.

FIG. 9 depicts a process flow diagram for processing an election in accordance with an exemplary embodiment of the present invention.

### DETAILED DESCRIPTION OF THE EXEMPLARY EMBODIMENTS

Exemplary embodiments of the present invention are provided. These embodiments include systems and methods for automatically processing corporate action events and any associated elections. These systems and methods enable straight through processing (STP) of corporate action events, including events requiring the election of optional events by a security holder.

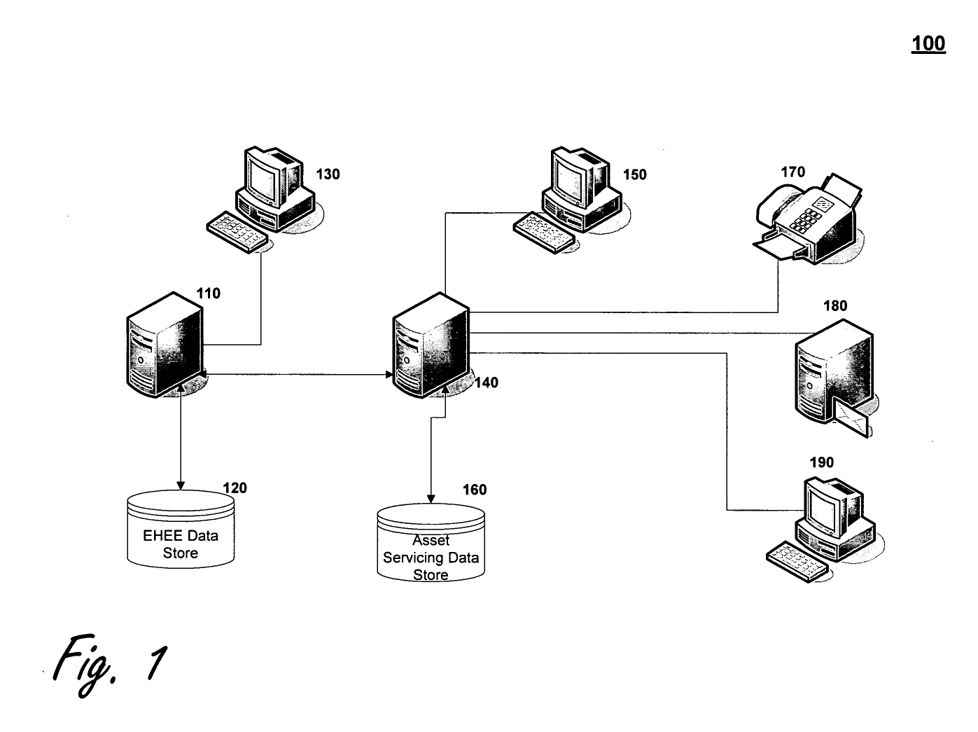

FIG. 1 depicts an operating environment 100 in accordance with an exemplary embodiment of the present invention. Referring to FIG. 1, the exemplary system includes an event, holding, entitlement, and election (EHEE) data server 110. The EHEE data server 110 receives data associated with corporate action events. These data may be received from a data clearinghouse (not shown) or, alternatively, from a third-party data processor (not shown), who processes data from the data clearinghouse for use by an asset servicing organization. In yet another alternative embodiment, the EHEE data server 110 can function as the data clearinghouse. In that embodiment, corporate action data would be received by the EHEE data server 110 from securities exchanges, corporations, government entities, asset servicing organizations, and other sources of raw data concerning corporate action events and resulting elections. The EHEE data server 110 may be pushed these data, may poll data sources to receive the data or a combination of both. The EHEE data server 110 is logically connected to an EHEE data store 120. The EHEE data store 120 allows the EHEE data server 110 to store corporate action events data. The EHEE data server 110 is also logically connected to one or more input/output devices, such as computer 130. Computer 130 can be used to access and to administer the EHEE data server 110.

Corporate action events begin with the issuer of a security. The issuer informs security holders of a specific event. This information may be conveyed directly to a security holder, generally through one or more intermediaries, or through a public announcement. Organizations that buy and sell securities for their customers generally provide asset servicing for those customers, including supporting processing corporate action events. The exemplary operating environment 100 may be employed by an asset servicing organization to process corporate action events for its customers, who hold securities in these corporations. Through this disclosure, these security holders are referred to as customers.

The exemplary operating environment 100 also includes an EHEE processing server 140. The EHEE processing server 140 processes data received by the EHEE data server 110 to generate corporate action event notification messages. This processing step includes harmonizing the received data and creating XML messages containing event notification information for further processing. This further processing includes sending notifications to security holders/customers affected by the corporate action event and receiving and acting on any election by those customers.

The EHEE processing server 140 is logically connected to an asset servicing data store 160. The EHEE processing server 140 stores new and updated EHEE data in the asset servicing data store 160. Also, the EHEE processing server 140 is logically connected to one or more input/output devices, such as computer 150. Computer 150 can be used to access and to administer the EHEE processing server 140.

The EHEE processing server 140 can communicate notification messages to security holders/customers using a variety of techniques. The EHEE processing server 140 may send a message to a facsimile gateway 170. The facsimile gateway 170 would then send facsimile messages to customers' facsimile machine for those customers affected by a corporate action event and who have chosen to be notified of such an event by facsimile message. Additionally, the EHEE processing server 140 could send an electronic mail message using an electronic mail message server 180. As with the facsimile message, the EHEE processing server 140 would send electronic mail messages to customers' email addresses for those customers affected by a corporate action event and who have chosen to be notified of such an event by email.

Also, the EHEE processing server 140 can notify customers through an asset servicing portal 190. The asset servicing portal 190 allows a customer to access information about securities held by that customer. For example, the asset servicing portal 190 may allow a customer to access a secure webpage that provides corporate action event notification and other information to the customer. The EHEE processing server 140 could host the secure website or a separate web server (not shown) could be used. Alternatively, the asset servicing portal 190 could employ a client-server architecture, where a customer using a client device and client software dials-up the asset servicing portal 190 to receive notifications and other information.

The exemplary operating environment depicts the EHEE data server 110 and EHEE processing server 140 as separate servers. One of ordinary skill in the art would appreciate that the operations of these two servers could be performed by a single physical server or by many distributed servers. Similarly, the EHEE data store 120 and asset servicing data store 160 could be a single database or could be multiple distributed databases.

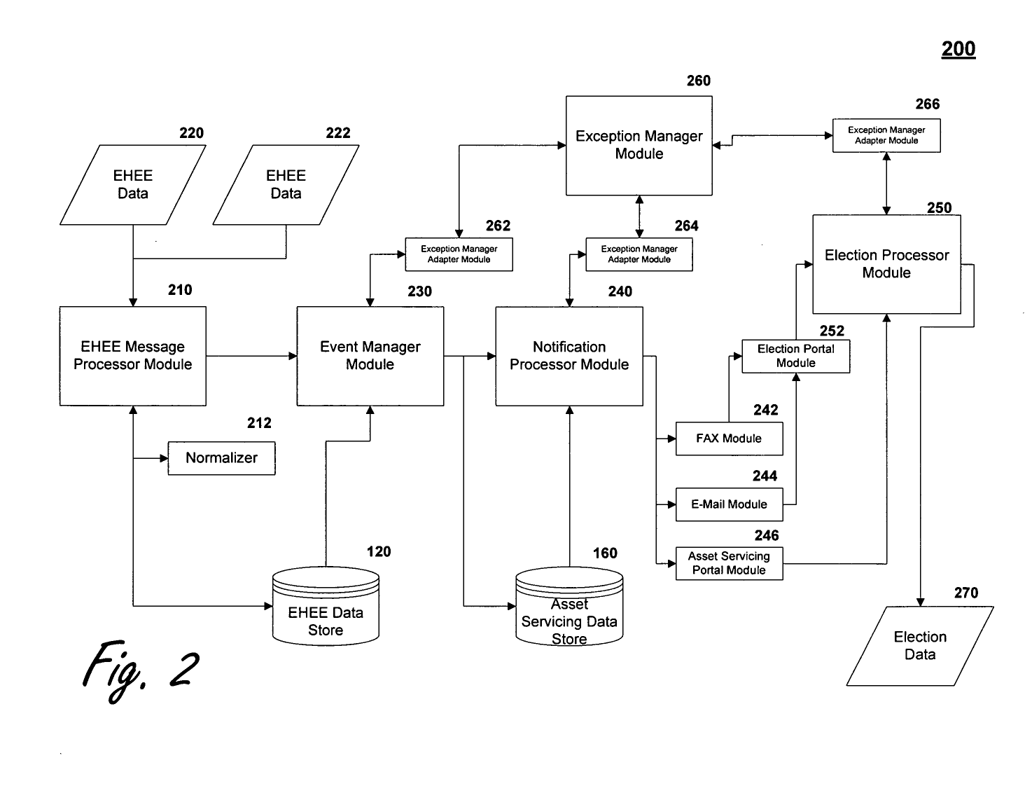

FIG. 2 depicts a software architecture 200 in accordance with an exemplary embodiment of the present invention. Referring to FIGS. 1 and 2, the exemplary software architecture 200 includes an EHEE message processor module 210. The EHEE message processor module 210 is operable to receive EHEE data, such as from EHEE data sources 220, 222. The EHEE data sources 220, 222 may include an EHEE data clearinghouse, a third-party data processor, or sources of direct corporate action event data, such as an issuer of a security. The EHEE message processor module 210 may poll the EHEE data sources 220, 222 for any new data to receive or alternatively, EHEE data sources 220, 222 may push data to the EHEE message processor module 210 or a combination of polling and pushing may take place.

The EHEE message processor module 210 includes a normalizer submodule 212. The normalizer submodule 212 is operable to normalize data received from a variety of data sources. In this process, the normalizer submodule 212 would convert incoming data to a common format or structure. For example, if one data source uses a variable name “CUST_ID” to represent a customer's identification number and a second data source uses a variable name “CUSTOMER_#,” the normalizer submodule 212 would map each of those data items into a common variable, such as “CUSTOMER_ID.” Also, some data from incoming data sources, such as EHEE data sources 220, 222, may not be needed for processing corporate action events. These data would not be mapped to data variables and instead would be removed from the data stream.

The EHEE message processor module 210 would interact with an EHEE data store 120. The EHEE message processor module 210 would create a message that is sent to the event manager module 230. This message would be in the form of an extensible mark-up language (XML) message. This message would contain only a few data items, such as a corporate action event identification number, a corporate action event version number, an EHEE identification number, and an impact. By limiting this message to these few data items, the EHEE message processor module 210 can efficiently communicate to the event manager module 230. The EHEE identification number is used to identify a record in the EHEE data store 120 that contains additional data associated with the corporate action event. In that way, the event manager module 230 can access the EHEE data store 120 to retrieve any necessary additional information, without that additional information being transmitted in the XML message from the EHEE message processor module 210.

One of ordinary skill in the art would understand that other message formats than XML could be used for the EHEE message sent from the EHEE message processor module 210 to the event manager module 230. Similarly, the message could contain more EHEE data than the data items identified above and could contain all of the data received regarding a certain corporate action event.

The event manager module 230 is capable of harmonizing data stored in the EHEE data store 120. Even after the normalizer submodule 212 of the EHEE message processor module 210 normalizes data, the actual data may differ in form. For example, EHEE data source 220 may provide a “CUST_ID” as an alphanumeric variable. EHEE data source 222 may provide its “CUSTOMER_#” as a fixed-width integer value. After the normalizer submodule 212 maps these data to a “CUSTOMER_ID” field, the event manager module 230 harmonizes the data to a common code, such as a variable length alphanumeric variable. In this way, subsequent processing of the data can rely on the data as being in a specific form.

The event manager module 230 is capable of extracting data from the EHEE data store 120. The event manager module 230 would use information from the message sent by the EHEE message processor module 210, such as an EHEE identification number, to retrieve the data necessary to generate a notification activity message. These data would be stored in the asset servicing data store 160.

A notification processor module 240 would prepare messages that notified security holder/customers of a specific corporate action event and, if applicable, options that are available to the customer related to the event. These notification messages would be in response to activity messages sent from the event manager module 230. Depending on the type of customer and the preferred method for notifying that customer, the notification processor module 240 would create an XML message that is then processed by a message gateway or portal, such as the facsimile gateway 170, the electronic mail message server 180, or the asset servicing portal 190. For example, the notification processor module 240 would send an XML message to a FAX module 242 to transmit a notification through the facsimile gateway 170 to a customer that prefers to receive action notifications by facsimile. Similarly, the notification processor module 240 would send an XML message to an e-mail module 244 to transmit a notification through the electronic mail message server 180 to a customer that prefers to receive action notifications by e-mail. For customers that can access the asset servicing portal 190, the notification processor module 240 would send an XML message to an asset servicing portal module 246 to transmit a notification through the asset servicing portal 190. For some organizations, the ability to access an asset servicing portal 190 may be limited to a certain category of customers.

A corporate action event notification message sent to a security holder, such as a customer of an asset servicing organization, would provide the security holder with the information necessary to make an election if the event required such an election. For example, a takeover is a corporate action event that is typically optional for the security holders. The security holders must choose whether to sell their shares of stock to the potential acquirer of the company for which they hold the stock. This election often includes a deadline upon which the option to act expires. Takeovers can be complex corporate action events, since offers may be revised, significantly altering the consequences of the event. Moreover, other potential acquirers, so called “white knights,” may come into the picture, creating another event. The notification message must lay out the options for the security holder as well as any deadlines and subsequent messages must update the action as necessary.

In contrast, some corporate action events do not require any action by a security holder. For example, a dividend payment is a mandatory action, where the security holder gets the dividend payment without any further action required. In that case, the notification message would provide details of the dividend and the action would be automatically processed without the need of feedback from the security holder. Of course, even a dividend payment may have an optional component, where a security owner may be able to use the dividend payment to acquire additional shares of stock in the company.

An election processor module 250 receives election data from a security holder/customer. A customer may use the asset servicing portal 190 to provide her election and the asset servicing portal module 246 would transmit that election information to the election processor module 250, in the form of an XML message. Again, other message formats could be used.

Other customers could send election data by facsimile or electronic mail. In the case of the former, the FAX module 242 would received the election data and transmit the election information to the election processor module 250. Similarly, with a customer that uses electronic mail, the e-mail module 242 would received the election data and transmit the election information to the election processor module 250. These transmission may go through a election portal module 252, which extracts the election data from the sent message. This extraction may be automatic, such as by using character recognition software or other automated means for determining election data or may involve manual intervention at this point. The election processor module 250 sends processed election data 270 to a data clearinghouse, which records the election. Alternatively, customers may send election data 270 directly to the data clearinghouse. The asset servicing organization may then receive this election information and process the election outcome. That is, it will alter the financial position of the customer based on the election, such as by buying or converting shares for the customer or by transferring cash to the customer.

The exemplary software architecture 200 also includes an exception manager module 260 for processing exceptions. An exception may be triggered when a message has incomplete information. In this case, a person may access an exception screen generated by the exception manager module 260 and view or fix the message to correct the exception. A corrected message record would then be stored back into the asset servicing database 160. The exception manager module 260 communicates with the event manager module 230, the notification processor module 240, and the election processor module 250 through exception manager adapter modules 262, 264, 266, respectively. These exception manager adapter modules 262, 264, 266 identify messages that include exceptions and that need to trigger the exception manager module 260.

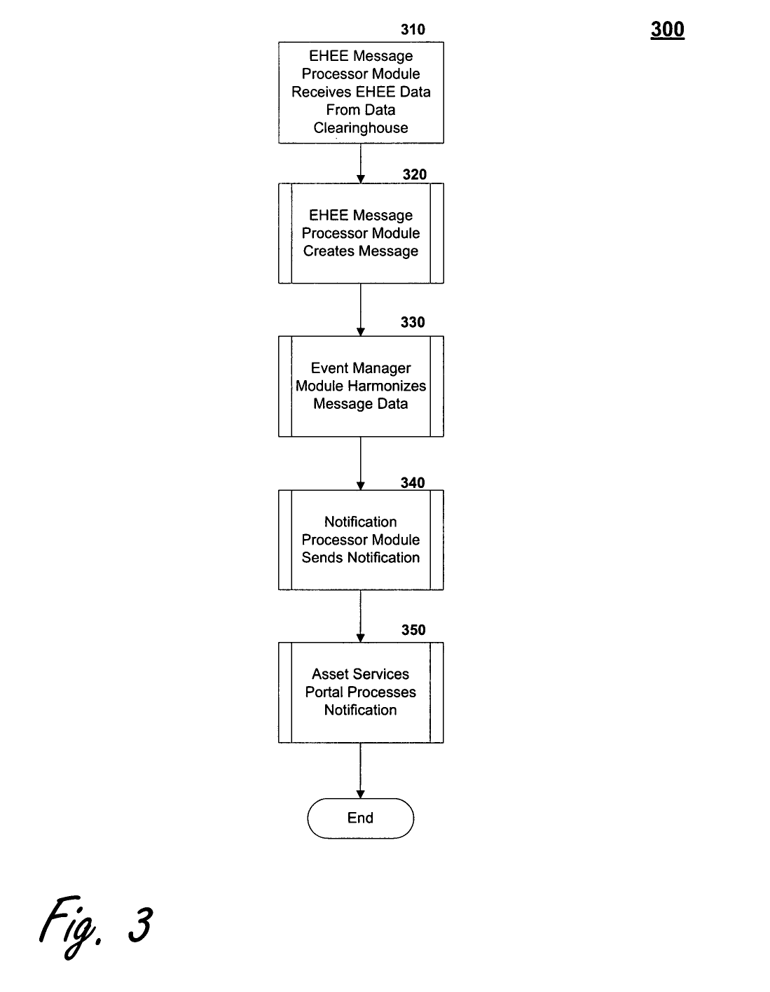

FIG. 3 depicts an overall process flow diagram 300 in accordance with an exemplary embodiment of the present invention. Referring to FIGS. 1, 2, and 3, at step 310, the EHEE message processor module 210 receives EHEE data from a data clearinghouse related to one or more corporate action events. This data clearinghouse may be a data clearinghouse such as the DTCC, may be a third-party data processor that processes data from sources such as the DTCC, or the system that includes the EHEE message processor module 210 may serve as its own data clearinghouse. Typically, data would be received in batches and may be related to a large number of diverse corporate action events. However, data could be received by the EHEE message processor module 210 that is limited to one specific corporate action event.

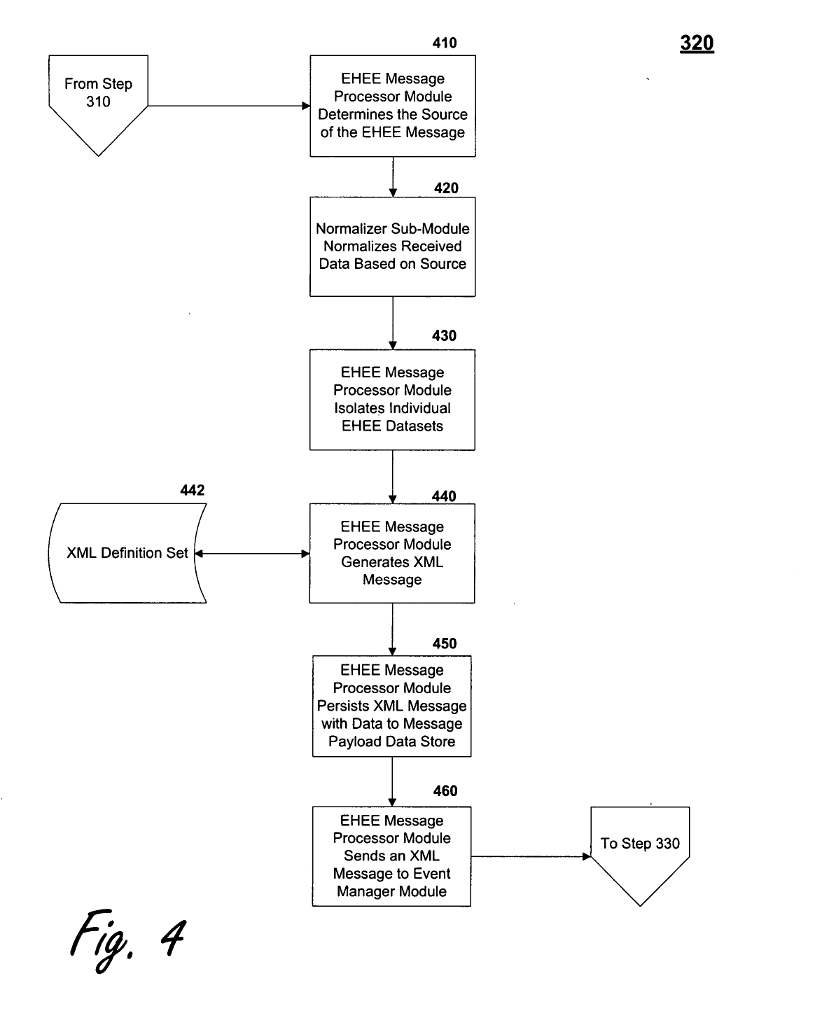

At step 320, the EHEE message processor module 210 creates an XML message regarding a corporate action event and sends the message to the event manager module 230. This step is discussed in greater detail below, in connection with FIG. 4.

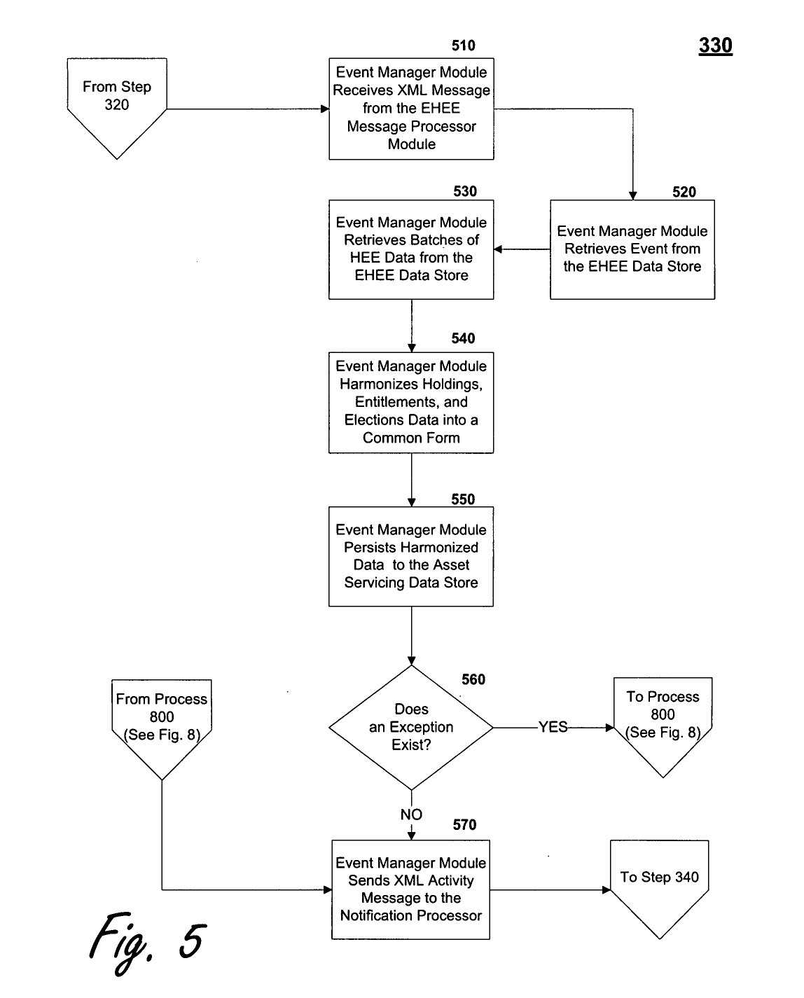

At step 330, the event manager module 230 harmonizes the EHEE data received at step 310 regarding a specific corporate action event. This step is discussed in greater detail below, in connection with FIG. 5.

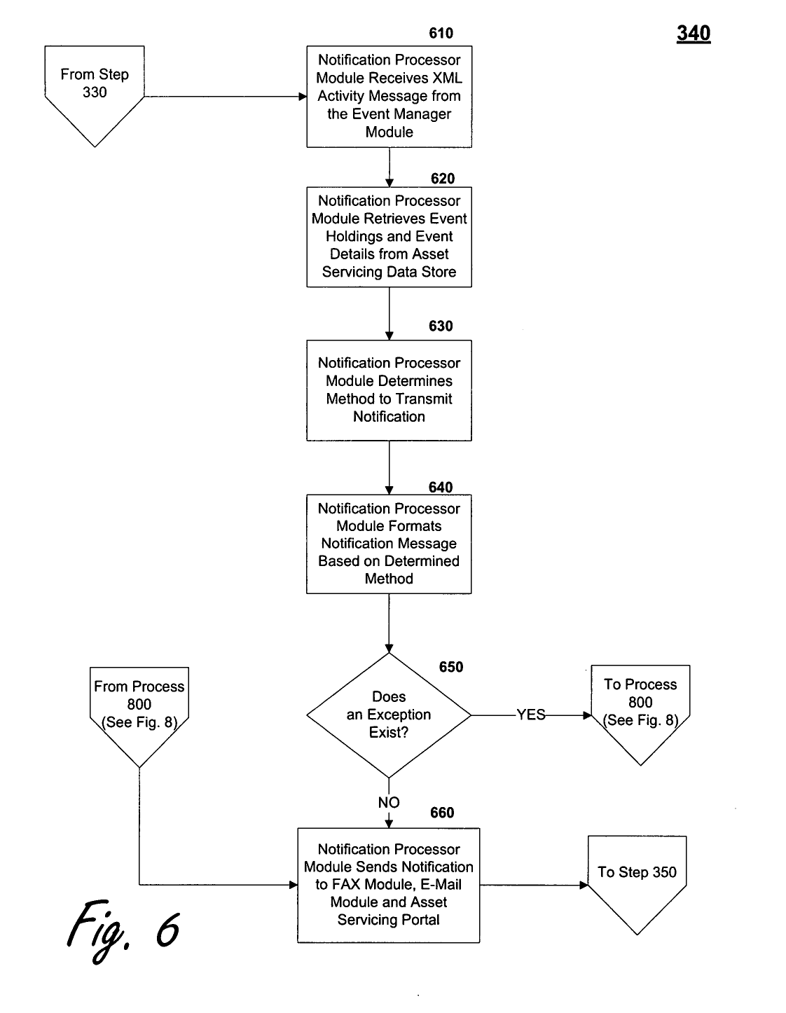

At step 340, the notification processor module 240 processes a message from the event manager module 230 and sends notification messages to security holders/customers affected by a specific corporate action event. This step is discussed in greater detail below, in connection with FIG. 6.

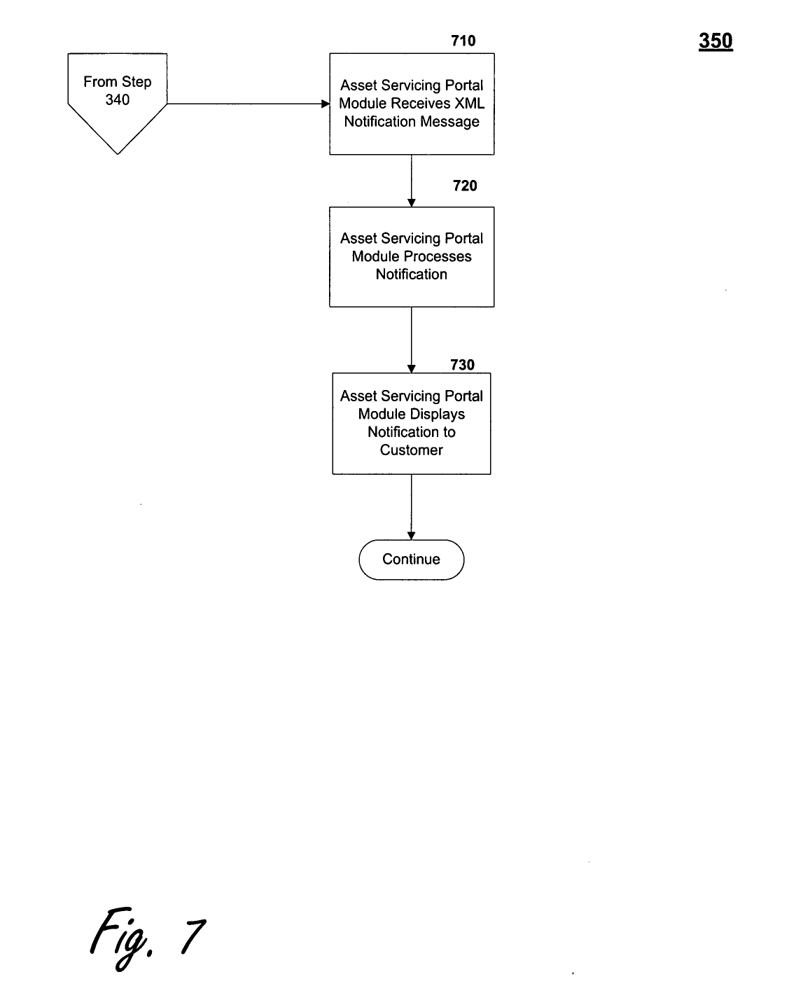

At step 350, the asset servicing portal module 246 receives a message from the notification processor module 240 for one or more security holders affected by a specific corporate action event. The affected customers would be able to access the asset servicing portal 190 to view a notification message. The asset servicing portal 190 would also receive an indication of the security holder's election for an action that permits the security holder to make an election. This step is discussed in greater detail below, in connection with FIG. 7.

FIG. 4 depicts a process flow diagram 320 for creating an event message in accordance with an exemplary embodiment of the present invention. Referring to FIGS. 1, 2, 3, and 4, at step 410, the EHEE message processor module 210 determines the source of the EHEE data received at step 310. At step 420, the normalizer submodule 212 normalizes the received data based on the data's source. For example, if the EHEE data is received from data source 220, the EHEE message processor module 210 would normalize the data based on a template, or data map, for data from data source 220. The normalizer submodule 212 would map the received data from the data source into the format and structure used by subsequent data processors, such as the notification processor module 240.

At step 430, the EHEE message processor module 210 isolates individual EHEE datasets. In this step, holdings, entitlements, and elections related to a single corporate action event are linked together. At step 440, the EHEE message processor module 210 generates an XML message regarding the corporate action event. This message is based on an XML definition set 442. This message can be referred to as an EHEE-“lite” message. In this exemplary embodiment, the message would include a limited amount of EHEE data, such as a corporate action event identifier, a corporate action event version, an impact (that is, if the event is “New,” “Updated,” or “Canceled”), and an EHEE identifier. A separate message would be generated for each data set isolated at step 430.

At step 450, the EHEE message processor module 210 persists the normalized EHEE data into the EHEE data store 120. These data would be associated with an EHEE identifier. In that way, the message generated at step 440 can be associated with the stored data. At step 460, the XML message generated at step 440 is sent to the event manager module 230.

FIG. 5 depicts a process flow diagram 330 for harmonizing event data in accordance with an exemplary embodiment of the present invention. Referring to FIGS. 1, 2, 4, and 5, at step 510, the event manager module 230 receives an XML message from the EHEE message processor module 210. At step 520, the event manager module 230 retrieves the corporate action event from the EHEE data store 120 associated with the received XML message. In this step, the event manager module 230 would query the EHEE data store with the EHEE identifier to retrieve the associated corporate action event.

At step 530, the event manager module 230 would retrieve batches of holdings, entitlements, and elections data from the EHEE data store 120. Each batch of data would correspond to a holder or category of holder of a security affected by the corporate action event. Of course, in an alternative embodiment, the EHEE message processor module 210 could directly send all of the EHEE data to the event manager module 230, eliminating the need to retrieve the data from the EHEE data store 120.

At step 540, the event manager module 230 harmonizes the EHEE data into a common form. At this step, the event manager module 230 converts the actual form of the data to a common code. For example, one data set may have an alphanumeric form while another data set may have an integer form for the same variable. The event manager module 230 would harmonize these forms into a common form. This common form would be needed for subsequent processing by the notification processor module 240 or other module that subsequently processes the EHEE data. One of ordinary skill in the art would appreciate that this harmonization step could be accomplished at the data normalization step 420.

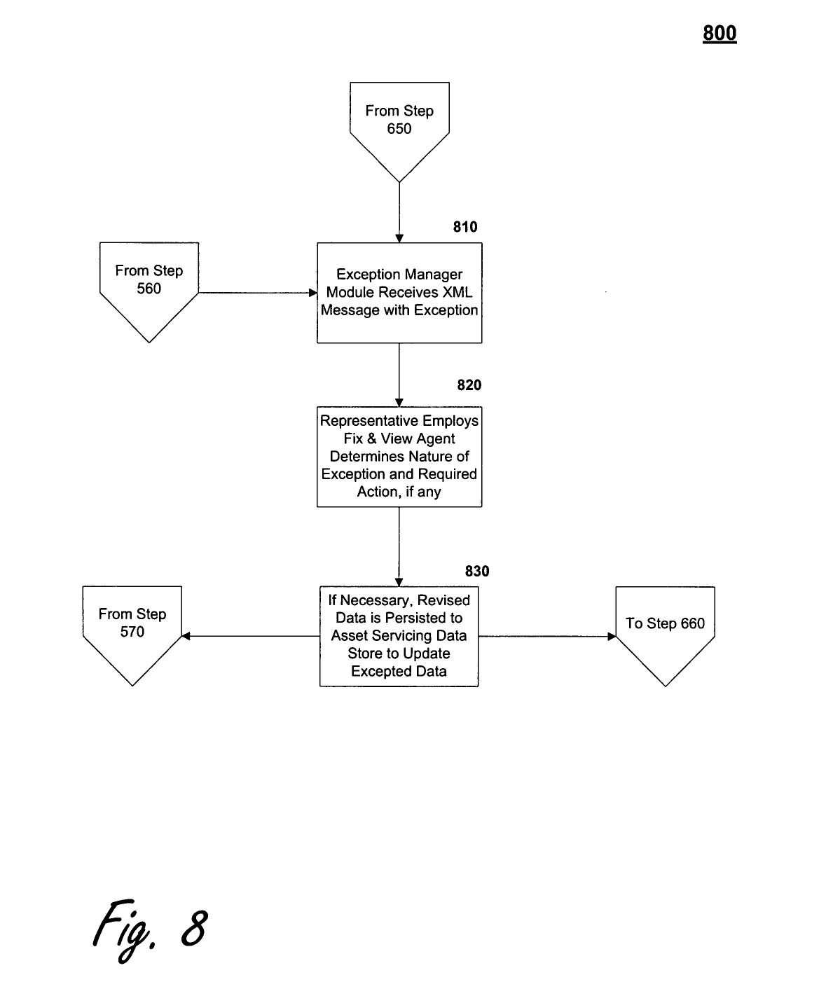

At step 550, the event manager module 230 persists the harmonized data to the asset servicing data store 160. The EHEE data would be associated to a single corporate action event identifier. At step 560, the exception manager adapter modules 262 determines if an exception exists with the data. If “YES,” the process 330 moves to process 800. Process 800 is discussed in greater detail below, in connection with FIG. 8. If “NO,” or after processing by process 800, the process 330 moves to step 570, where the event manager module 230 sends an XML activity message to the notification processor module 240. This message would include an corporate action event identifier and an impact. Some exemplary messages would include “New Event Received,” “Updated Key Economics,” “Updated Notification Data Received,” “Updated Economics and Data,” “Updated Key Dates,” and “Cancelled Event Received.”

FIG. 6 depicts a process flow diagram 340 for processing event notification in accordance with an exemplary embodiment of the present invention. Referring to FIGS. 1, 2, 5, and 6, at step 610, the notification processor module 240 receives an XML activity message from the event manager module 230. At step 620, the notification processor module 240 retrieves event holdings and event details from the asset servicing data store 160. These data were persisted to this database at step 550. In the case where the message triggers an exception, these data may be updated by the exception manager module 260. The operation of the exception manager module 260 is discussed in further detail in connection with FIG. 8, below. Although this exemplary embodiment employs XML messaging, one of ordinary skill in the art would understand that other message types could be used.

At step 630, the notification processor module 240 determines the method for transmitting a notification message to a security holder/customer. Methods may include facsimile transmission, electronic mail transmission, or presentation through the asset servicing portal 190. One of ordinary skill in the art would appreciate that facsimile transmission, electronic mail transmission, or presentation through the asset servicing portal 190 represents only a few possible communication methods. Other communication methods, such as short message service (SMS) messaging, paging, or other text messaging, automated voice messaging, or telex, could be used.

At step 640, the notification processor module 240 formats a notification message regarding the specific corporate action event associated with the activity message received at step 610 based on the transmission method determined at step 630.

At step 650, the exception manager adapter modules 264 determines if an exception exists with the data. If “YES,” the process 340 moves to process 800. Process 800 is discussed in greater detail below, in connection with FIG. 8. If “NO,” or after processing by process 800, the process 340 moves to step 660, where the notification processor module 240 sends the formatted message to the appropriate gateway. These gateways may include the facsimile gateway 170, the electronic mail message server 180, or the asset servicing portal 190.

FIG. 7 depicts a process flow diagram 350 for an asset services portal 190 processing an event notification in accordance with an exemplary embodiment of the present invention. Referring to FIGS. 1, 2, and 7, at step 710, the asset servicing portal module 246 receives an XML notification message from the notification processor module 240. At step 720, the asset servicing portal module 246 processes the notification. This processing includes formatting the information for presentation through the asset servicing portal 190.

At step 730, the asset servicing portal module 246 presents the notification to a security holder/customer through the asset servicing portal 190. The customer would access the asset servicing portal 190 by accessing a site on the World Wide Web that allows the customer to access such information. The customer would likely supply a username and password or other security measures to access a secure web server that would provide the notification information. Alternatively, the customer may access the asset servicing portal 190 by dialing into the asset servicing portal 190 using a client device and a modem. The security holder/customer would still likely supply a username and password or other security measures to access the notification. In either case, the asset servicing portal 190 would display the notification to the s customer.

FIG. 8 depicts a process flow diagram 800 for processing an exception in accordance with an exemplary embodiment of the present invention. Referring to FIGS. 1, 2, 5, 6, and 8, at step 810, the exception manager module 810 receives an XML message containing an exception. An exception may include a message or data stream that is missing a data item. The exception would have been detected by an exception manager adapter module, such as exception manager adapter module 262, 264, 266. These modules would access data messages and other data streams and evaluate their content. Established rules would be employed to determine if an exception exists.

At step 820, a representative employs a fix and view agent to determine the nature of the exception and any required action. The representative would access the exception information using a graphical user interface. Fix and view agents are tools that assist the representative in providing the correct action to an exception and may be developed for each type of exception. At step 830, the data associated with the exception is updated as necessary and the exception manager module 810 persists the updated data to the asset servicing data store 160. This updating operation triggers the further processing of the data, as necessary, such as at step 570 of process 330 or step 660 of process 340.

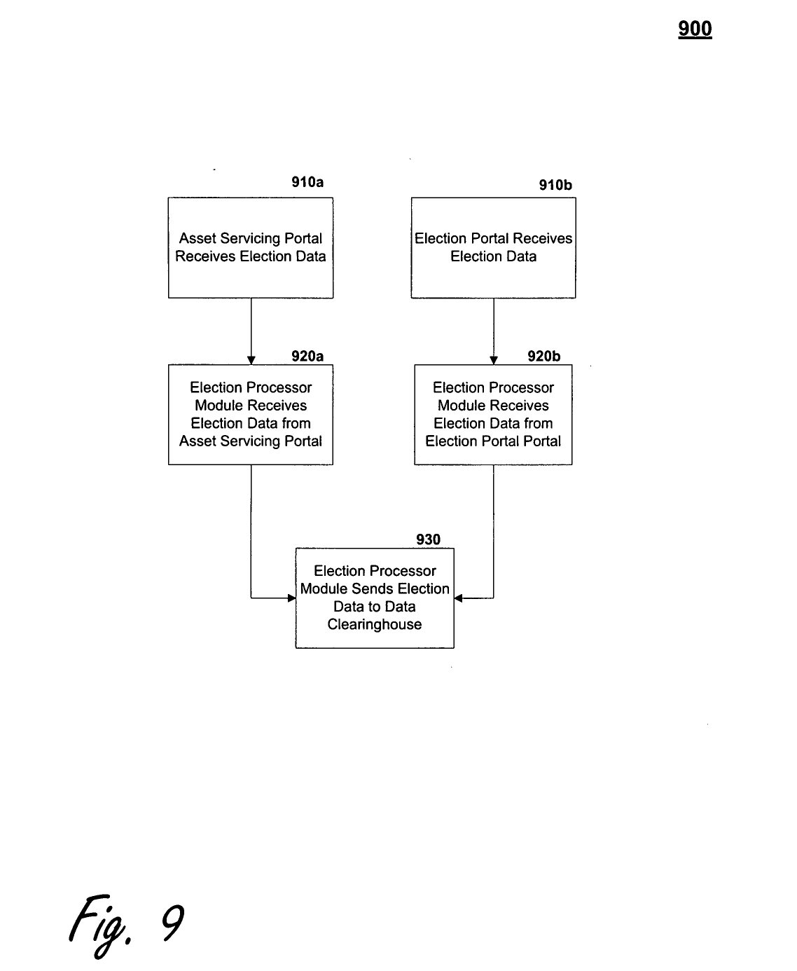

FIG. 9 depicts a process flow diagram 900 for processing an election in accordance with an exemplary embodiment of the present invention. Referring to FIGS. 1, 2, and 9, process 900 includes two branches, an “a” branch (steps 910a and 920a) and a “b” branch (steps 910b and 920b). These “a” and “b” branches represent data received through the asset servicing portal 190 or by other means, respectively.

At step 910a, the asset servicing portal 190 receives election data from a security holder/customer. The customer would use an input device, such as a keyboard, mouse, or similar device, to select an option related to the corporate action event in the notification. The asset servicing portal module 246 would receive the indication of that election. At step 920a, the election processor module 250 receives the election data from the asset servicing portal 190 and processes the data for transmission to a data clearinghouse or other user of the election data.

Similarly, as step 910b, the election portal module 252 receives election data. The election portal module 252 may receive this data by processing an incoming facsimile or electronic mail message. The election portal module 252 may employ character recognition or other known processes to parse the election data from these messages. At step 920b, the election processor module 250 receives the election data from the election portal module 252. Alternatively, these data may be entered manually into the election portal module 252.

At step 930, the election processor module 250 sends the election data 270 to a data clearinghouse. This data clearinghouse could be a national data clearinghouse, a third-party vendor, or a system integral with the exemplary system 200. The election data is then distributed such that the resulting outcome can be implemented, such as buying, selling, or converting the security.

One of ordinary skill in the art would appreciate that the present invention provides systems and methods for processing and communicating corporate action events and any associated elections. These systems and methods enable straight through processing of corporate action events, including events requiring the election of optional events by a security holder. These systems and methods would receive and process data regarding corporate action events. These data would be processed and notifications sent to affected security holders. For events that require the security holder to make an election, the systems and methods may receive and process those elections. The elections would then be used to implement the resulting outcome. An exemplary embodiment of the present invention would employ XML messaging in the automation process. The systems and methods may also include a process that can identify and, if possible, fix an exception to a message or data stream. Also, an asset servicing portal may be used for communicating notifications and elections.

What is claimed:

1. A system for processing corporate action events comprising:
an event, holdings, entitlement, and election (EHEE) message processor module operable to receive data associated with a corporate action event; and
a notification processor module, logically connected to the EHEE message processor module and operable to process the received data associated with a corporate action event and automatically create a notification message, wherein the notification message comprises an option that must be taken by a holder of a security affected by the corporate action event.

2. The system of claim 1 further comprising an event manager module operable to harmonize the received data associated with a corporate action event into a common form.

3. The system of claim 1 further comprising an asset servicing portal, operable to communicate the notification message to the holder of a security affected by the corporate action event.

4. The system of claim 3 wherein the asset servicing portal is further operable to receive an election from the holder of a security affected by the corporate action event.

5. The system of claim 1 further comprising an exception manager module, operable to identify and correct an exception with the notification message.

6. The system of claim 5 wherein the exception is automatically detected by the exception manager module.

7. The system of claim 1 further comprising an election processor module operable to receive an election from the holder of a security affected by the corporate action event in response to the notification message.

8. The system of claim 7 wherein the election processor module is operable to extract the election from a electronic mail message.

9. The system of claim 7 wherein the election processor module is operable to extract the election from a facsimile message.

10. The system of claim 1 wherein the EHEE message processor module communicates with the notification processor module through an extensible markup language (XML) message.

11. The system of claim 1 further comprising a fax module operable to send the notification method as a facsimile message.

12. The system of claim 1 further comprising an email module operable to send the notification method as an electronic mail message.

13. A method for processing corporate action events comprising the steps of:
receiving EHEE data associated with a corporate action event from an EHEE data clearinghouse;
automatically generating a notification message to notify a holder of a security affected by the corporate action event, wherein the notification message comprises an option that must be taken by the security holder; and
sending the notification message to the holder of a security affected by the corporate action event.

14. The method of claim 13 further comprising the step of harmonizing the received EHEE data prior to generating the notification message.

15. The method of claim 13 wherein the step of sending the notification message to the holder of a security affected by the corporate action event comprises communicating the notification message to the holder of a security affected by the corporate action event through an asset servicing portal.

16. The method of claim 15 wherein the notification message comprises a secure webpage.

17. The method of claim 13 further comprising the step of receiving an election of an option in response to sending the notification message.

18. The method of claim 17 further comprising the step of processing an outcome that results from the received election.

19. The method of claim 13 further comprising the steps of:
automatically identifying an exception related to the notification message; and
correcting the exception.

20. The method of claim 13 wherein the step of sending the notification message comprises sending a facsimile message.

21. The method of claim 13 wherein the step of sending the notification message comprises sending an electronic mail message.

22. A system for processing corporate action events comprising:
an event, holdings, entitlement, and election (EHEE) message processor module operable to receive data associated with a corporate action event;
a notification processor module, logically connected to the EHEE message processor module and operable to process the received data associated with a corporate action event and automatically create a notification message, wherein the notification message comprises an option that must be taken by a holder of a security affected by the corporate action event;
an asset servicing portal, operable to communicate the notification message to the holder of a security affected by the corporate action event; and
an election processor module operable to receive an election from the holder of a security affected by the corporate action event in response to the notification message.

23. The system of claim 22 wherein the asset servicing portal is further operable to receive an election from the holder of a security affected by the corporate action event.

24. The system of claim 22 wherein the asset servicing portal communicates the notification message through a webpage.

25. A system for processing corporate action events comprising:
an event, holdings, entitlement, and election (EHEE) message processor module operable to receive data associated with a corporate action event from a plurality of EHEE data providers and normalize the received data; and
a notification processor module, logically connected to the EHEE message processor module and operable to process the received data associated with a corporate action event and automatically create a notification message, wherein the notification message comprises an option that must be taken by a holder of a security affected by the corporate action event.

26. The system of claim 25 further comprising an event manager module operable to harmonize the received data associated with corporate action events into a common form.

27. The system of claim 26 further comprising an asset servicing portal, operable to communicate the notification message to the holder of a security affected by the corporate action event.

28. The system of claim 27 wherein the asset servicing portal is further operable to receive an election from the holder of a security affected by the corporate action event.

29. The system of claim 25 further comprising an exception manager module, operable to identify and correct an exception with the notification message.

30. The system of claim 29 wherein the exception is automatically detected by the exception manager module.

31. The system of claim 25 further comprising an election processor module operable to receive an election from the holder of a security affected by the corporate action event in response to the notification message.

32. The system of claim 31 wherein the election processor module is operable to extract the election from a electronic mail message.

33. The system of claim 31 wherein the election processor module is operable to extract the election from a facsimile message.

34. The system of claim 25 wherein the EHEE message processor module communicates with the notification processor module through an extensible markup language (XML) message.

35. The system of claim 25 further comprising a fax module operable to send the notification method as a facsimile message.

36. The system of claim 25 further comprising an email module operable to send the notification method as an electronic mail message.
